(19) United States
(12) Patent Application Publication
(10) Pub. No.: US 2015/0005121 A1
(43) Pub. Date: Jan. 1, 2015

(54) V-BELT FOR HIGH LOAD TRANSMISSION

(71) Applicant: BANDO CHEMICAL INDUSTRIES, LTD., Kobe-shi (JP)

(72) Inventor: Hiroyuki Sakanaka, Kobe-shi (JP)

(21) Appl. No.: 14/486,839

(22) Filed: Sep. 15, 2014

Related U.S. Application Data
(63) Continuation of application No. PCT/JP2013/001846, filed on Mar. 18, 2013.

(30) Foreign Application Priority Data
Mar. 19, 2012 (JP) 2012-061605

(51) Int. Cl. F16G 5/20; F16G 1/28

(52) U.S. Cl. CPC F16G 5/20; F16G 1/28
USPC 474/204

(57) ABSTRACT

A V-belt for high load transmission includes numbers of blocks engaged with and fixed to tension bands. Power is transmitted by meshing teeth of the blocks with grooves of the tension bands. A belt pitch width a being a width of each block at a position of a cord of each tension band, and a meshing thickness b of the tension band between bottoms of upper recesses and bottoms of lower recesses of the tension band satisfy a relationship of b/a≦0.08. (That is, the meshing thickness b of each tension band is 8% or smaller of the belt pitch width a). The meshing thickness b of the tension band and a total thickness c of the tension band being a thickness of each of cogs, which are portions of the tension band other than the upper and lower recesses, satisfy a relationship of c/b≧2.0.

### CROSS-REFERENCE TO RELATED APPLICATIONS

This is a continuation of International Application No. PCT/JP2013/001846 filed on Mar. 18, 2013, which claims priority to Japanese Patent Application No. 2012-061605 filed on Mar. 19, 2012. The entire disclosures of these applications are incorporated by reference herein.

### BACKGROUND

The present disclosure relates to V-belts for high load transmission, and more particularly to those preferably used for belt-type continuously variable transmissions.

This type of V-belts for high load transmission have been well known, and wound around variable speed pulleys of, for example, belt-type continuously variable transmissions. Each V-belt for high load transmission includes tension bands, each having numbers of, for example, upper and lower recessed grooves arranged at regular intervals in the upper surface facing the back of the belt and the lower surface facing the bottom of the belt in the belt length direction to vertically correspond to each other. Each V-belt also includes numbers of blocks, each including fit portions in which the tension bands are press-fitted, for example, an upper projecting tooth formed in the upper surfaces of the fit portions and meshing with the upper grooves of the tension bands, and, for example, a lower projecting tooth formed in the lower surfaces of the fit portions and meshing with the lower grooves of the tension bands. The V-belts are also called block belts.

Each tension band includes a cord reducing expansion of the belt and transmitting power, a shape-retaining rubber layer, a canvas reducing friction with the blocks, etc.

The blocks are made of resin such as phenolic resin. Each block includes an upper beam at the back of the belt, and a lower beam at the bottom of the belt. The fit portions of the tension bands are formed between the upper and lower beams.

The tension bands are press-fitted in the fit portions of the blocks, thereby engaging the blocks with the tension bands, with the projecting teeth and the recessed grooves meshing at regular intervals in the belt length direction. The teeth of the blocks and the grooves of the tension bands are integrated by the meshing to transmit power.

Japanese Patent No. 4256498 shows such a V-belt for high load transmission. The meshing thickness of each block, which is the height of the gap between the lower ends of the upper teeth and the upper ends of the lower teeth, is smaller than the meshing thickness of each tension band between the lower ends of the upper grooves and the upper ends of the lower grooves. As such, a fastening margin is provided, which is the difference in the meshing thickness between each block and the tension band. At the same time, a protruding margin is provided, which is the protrusion of the outer end surface of the tension band beyond the contact surfaces of the blocks with a pulley. Optimization of the fastening margin and the protruding margin is suggested.

Japanese Patent No. 4624759 teaches restricting the holding force of blocks and the width of a tension band. Japanese Patent Unexamined Publication No. 2002-13594 and Japanese Patent Unexamined Publication No. 2003-156103 teach reducing wear of rubber or a canvas of a tension band to reduce the change in the fastening margin.

Example sizes of the components of the V-belts for high load transmission follow. The block width, which is the width of each block in the belt width direction, is, for example, 25 mm. The meshing thickness of each block is, for example, 3 mm. The meshing thickness of each tension band ranges, for example, from 3.03 to 3.15 mm. The fastening margin ranges from 0.03 to 0.15 mm. The total thickness of the tension band, which is the thickness of the portions (i.e., cogs) of the tension band other than the upper and lower grooves, ranges from, for example, 4.6 to 4.7 mm. The protruding margin of the outer end surface of the tension band, which is the protrusion beyond the contact surfaces of the blocks with a pulley, ranges from, for example, 0.05 to 0.15 mm.

### SUMMARY

In these V-belts for high load transmission, there is a difference in the coefficient of thermal expansion between the rubber, which is the component of each tension band, and the resin of the blocks. When the belt is used in a transmission and runs, the difference in the coefficient causes thermal expansion of the tension band and increases the flexural rigidity of the belt particularly at the initial running stage (at the start of using), thereby reducing the transmission efficiency and further generating heat in the belt. As a result, the characteristics of the tension band deteriorate.

Due to the thermal expansion of the tension band, the lower beams of the blocks are bound to the tension band, and are not pushed up. However, the upper beams are pushed up at the back of the belt to increase the distance between the upper and lower beams. The side surfaces of the lower beams mainly abut on the groove surface of the pulley. Then, thrust is applied from the groove surface of the variable speed pulley to the side surfaces of the belt in the width direction, thereby generating the belt tension. The thrust-tension conversion ratio at this time decreases to reduce the belt tension.

After that, when the tension band is fatigued with the running of the belt, the expansion of the upper beams decreases, and the side surfaces of the upper beams also abut on the groove surface of the pulley. As a result, the thrust-tension conversion ratio increases to increase the belt tension back to the original.

As such, as the running time passes from the initial running stage of the belt, the contact section of the side surfaces of the blocks with the pulley changes, thereby changing the thrust-tension conversion ratio to change the tension generated in the belt.

The thrust-tension conversion ratio is changed by other factors such as the radial positions of the blocks fitted in the grooves of the variable speed pulley, and the coefficient of friction between the belt and the groove surface of the pulley. Thus, a drive unit opening and closing the variable speed pulley is set to have excessive thrust including a safety factor to some extent. This increases the load applied to the belt to deteriorate the durability and increase noise. There is thus a demand for development in V-belts for high load transmission, in which the contact state between the upper and lower beams of blocks and the groove surface of the pulley does not temporally change.

In Japanese Patent No. 4256498, however, the change in the thrust-tension conversion ratio cannot be reliably reduced due to the thermal expansion and the permanent deformation of rubber. In Japanese Patent Unexamined Publication No. 2002-13594 and Japanese Patent Unexamined Publication No. 2003-156103, the change in the fastening margin is difficult to reliably reduce.

In order to reduce the thermal expansion of a tension band, which pushes up the upper beams of the blocks, it is effective to reduce the meshing thickness of the tension band (the thickness of the tension band between the lower ends of the upper grooves and the upper ends of the lower grooves). However, when the meshing thickness of the tension band decreases, and when the blocks vibrate such that the upper and lower beams move in the opposite directions along the belt length, the distance between the point of action and the fulcrum decreases. Then, the blocks tend to vibrate to be damaged.

The present disclosure aims to reduce a temporal change in belt tension according to a change in a thrust-tension conversion ratio from the initial running stage of the belt, and thrust of a drive unit to reduce the initial heat built-up of the belt and to improve the efficiency and the durability of the belt by specifying the size ratio of predetermined components of a V-belt for high load transmission.

The present disclosure provides a V-belt for high load transmission including tension bands, each including a cord buried inside a shape-retaining rubber layer, and numbers of upper and lower grooves arranged in a belt length direction to vertically correspond to each other, the upper grooves being formed in an upper surface facing a back of the belt, and the lower grooves being formed in a lower surface facing a bottom of the belt; and numbers of blocks, each including fit portions in which the tension bands are press-fitted, an upper tooth formed in upper surfaces of the fit portions and meshing with the upper grooves of the tension bands, and a lower tooth formed in lower surfaces of the fit portions and meshing with the lower grooves of the tension bands. The tension bands are fitted in the fit portions of the blocks, thereby engaging and fixing the blocks with and to the tension bands. Meshing of the teeth of the blocks with the grooves of the tension bands transmits power.

Based on the assumption, a belt pitch width a being a belt width at a position of the cord of each tension band, and a meshing thickness b of the tension band between lower ends of the upper grooves and upper ends of the lower grooves satisfy a relationship of b/a≦0.08 (i.e., the meshing thickness b of the tension band is 8% or smaller of the belt pitch width a). In addition, the meshing thickness b of the tension band and a total thickness c of the tension band being a thickness of each of cogs, which are portions of the tension band other than the upper and lower grooves, satisfy a relationship of c/b≧2.0 (i.e., the total thickness c of the tension band is two or more times as great as the meshing thickness b of each tension band).

In this structure, since the belt pitch width a and the meshing thickness b of the tension band satisfy the relationship of b/a≦0.08, the ratio of the meshing thickness b of the tension band to the belt pitch width a is sufficiently small. Thus, the upper beams of the blocks are not pushed up by the thermal expansion of the tension band. Even when the thrust-tension conversion ratio changes with the running time of the belt, the belt tension does not change. As a result, the thrust of the drive unit decreases to reduce the initial heat built-up of the belt and to improve the efficiency and the durability of the belt.

Since the belt pitch width a and the meshing thickness b of the tension band satisfy the relationship of b/a≦0.08, the tension band becomes thin, thereby reducing the holding force of the blocks. However, the total thickness c of the tension band and the meshing thickness b satisfy the relationship of c/b≧2.0 to increase the total thickness c of the tension band at the cogs. The blocks are also held by the cogs of the tension band with a great thickness. Thus, the holding force of the tension band holding the blocks does not decrease, thereby reliably reducing vibrations of the blocks.

The effects and advantages cannot be obtained if the belt pitch width a and the meshing thickness b of the tension band satisfy the relationship of b/a>0.08 (i.e., the meshing thickness b of the tension band is greater than 8% of the belt pitch width a) or if the total thickness c of the tension band and the meshing thickness b satisfy the relationship of c/b<2.0 (i.e., the total thickness c of the tension band is smaller than 2 times the meshing thickness b of each tension band).

A ratio b/a of the meshing thickness b of the tension band to the belt pitch width a may range from 0.04 to 0.08 (i.e., the meshing thickness b of the tension band may range from 4% to 8% of the belt pitch width a).

The belt pitch width a and the meshing thickness b of the tension band may satisfy a relationship of b/a≦0.05 (the meshing thickness b of the tension band may be 5% or smaller of the belt pitch width a).

A ratio c/b of the total thickness c of the tension band to the meshing thickness b of the tension band may range from 2.0 to 4.6.

The meshing thickness b of the tension band may range from 1.0 to 2.0 mm. The total thickness c of the tension band may range from 2.2 to 5.5 mm.

This structure more effectively reduces the change in the thrust-tension conversion ratio caused by a temporal change in the belt in running.

The V-belt for high load transmission may be wound around a variable speed pulley of a belt-type continuously variable transmission.

This structure provides a suitable V-belt for high load transmission effectively exhibiting the above-described advantages.

According to the present disclosure, the belt pitch width a of the V-belt for high load transmission and the meshing thickness b of the tension band satisfy the relationship of b/a≦0.08, and the meshing thickness b of the tension band and the total thickness c satisfy the relationship of c/b≧2.0. This reduces the temporal change in the belt tension from the initial running stage of the belt according to the change in the thrust-tension conversion ratio. As a result, the thrust of the unit decreases to reduce the initial heat built-up of the belt, and to improve the efficiency and the durability of the belt.

### BRIEF DESCRIPTION OF THE DRAWINGS

FIG. 1 is a perspective view of a V-belt for high load transmission according to an embodiment of the present disclosure.

FIG. 2 is a side view of the V-belt for high load transmission.

FIG. 3 is a cross-sectional view taken along the line of FIG. 2.

FIG. 4 is an enlarged side view of a tension band.

FIG. 5 is an enlarged side view of a block.

FIG. 6 illustrates equipment for measuring and testing belt tension.

FIG. 7 illustrates equipment for testing high-speed durability.

FIG. 8 illustrates equipment for testing transmission capability.

FIG. 9 illustrates a first half of test results of examples and the comparative examples.

FIG. 10 illustrates the other half of the test results of the examples and the comparative examples.

FIG. 11 illustrates the relationship between the ratio of a meshing thickness of each tension band to a belt pitch width, and a change in the belt tension (i.e., inter-shaft power) in each of the examples and the comparative examples.

FIG. 12 illustrates the relationship between the ratio of the meshing thickness of the tension band to the belt pitch width, and high-speed durability in each of the examples and the comparative examples.

FIG. 13 illustrates the relationship between the ratio of the meshing thickness of the tension band to the belt pitch width, and an initial heating temperature in each of the examples and the comparative examples.

FIG. 14 illustrates the relationship between the ratio of the meshing thickness of the tension band to the belt pitch width, and a change in a fastening margin in each of the examples and the comparative examples.

FIG. 15 illustrates the relationship between the ratio of the meshing thickness of the tension band to the belt pitch width, and transmission torque at a slip of 2% in each of the examples and the comparative examples.

FIG. 16 illustrates the relationship between the ratio of the meshing thickness of the tension band to the belt pitch width, and belt efficiency in each of the examples and the comparative examples.

FIG. 17 illustrates the relationship among variations in the belt tension (i.e., inter-shaft power), the ratio of the meshing thickness of the tension band to the belt pitch width, and the ratio of the total thickness to the meshing thickness of the tension band.

FIG. 18 illustrates the relationship among variations in a fastening margin, the ratio of the meshing thickness of the tension band to the belt pitch width, and the ratio of the total thickness to the meshing thickness of the tension band.

### DETAILED DESCRIPTION

An embodiment of the present disclosure will be described hereinafter in detail with reference to the drawings. The following description of the preferred embodiment is intrinsically a mere example, and is not intended to limit the present disclosure, equivalents, and application.

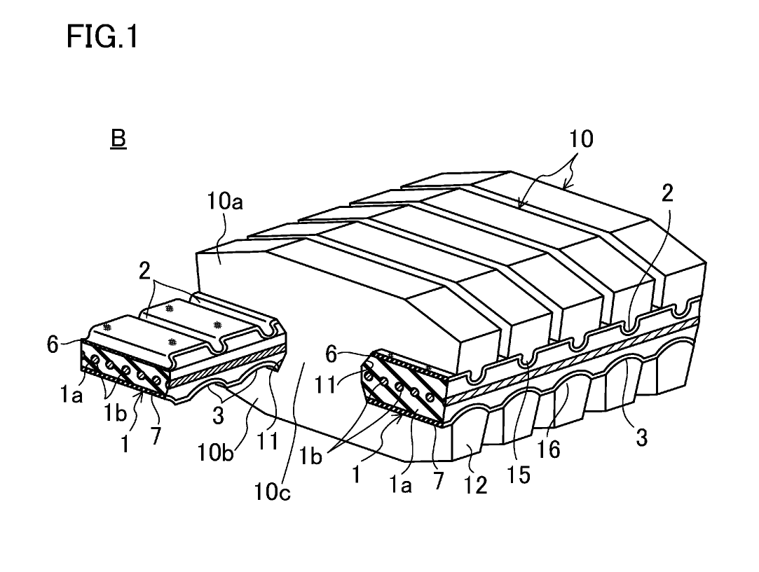

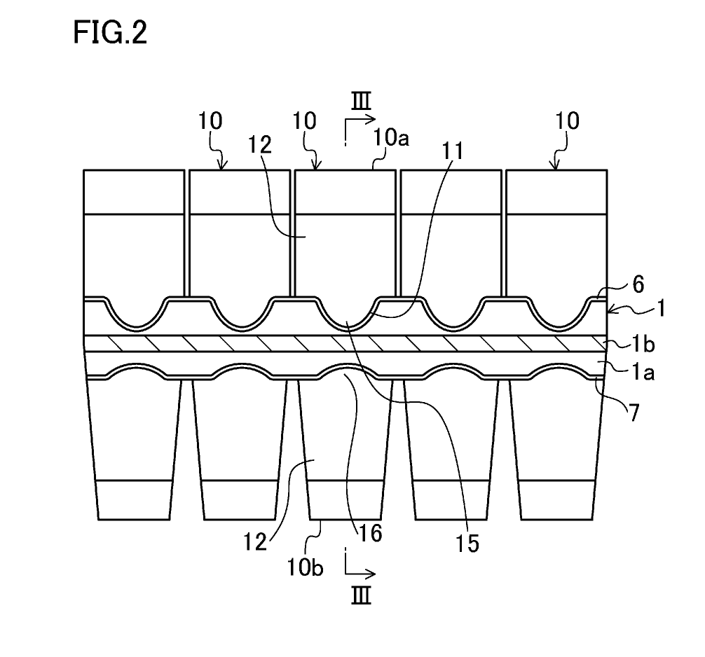

FIGS. 1-3 illustrate a V-belt B for high load transmission according to an embodiment of the present disclosure. Although not shown, this belt B is wound around a plurality of variable speed pulleys of, for example, a belt-type continuously variable transmission. The belt B includes a pair of right and left endless tension bands 1 and 1, and numbers of blocks 10, 10, . . . continuously engaged with and fixed to these tension bands 1 and 1 in the belt length direction.

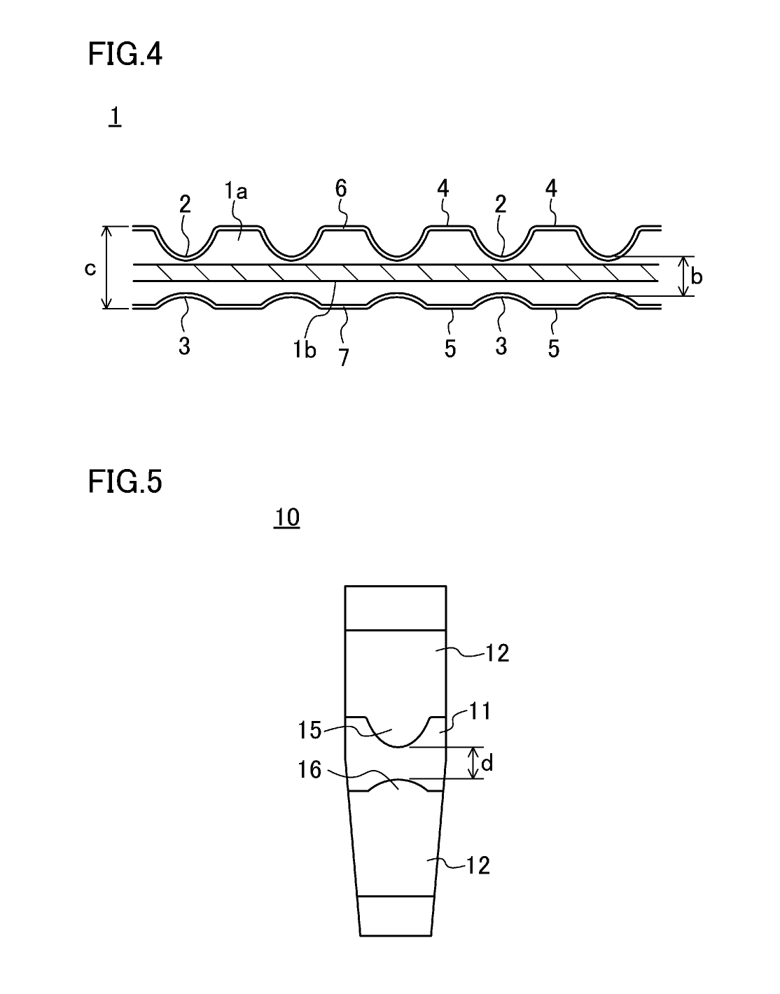

As also shown in FIG. 4, each of the tension bands 1 is formed by burying a plurality of cords (core bodies) 1b, 1b, . . . , which are made of a high-strength, high-elastic modulus material such as aramid fibers, in spiral inside a shape-retaining rubber layer 1a made of hard rubber. In the upper surface of each tension band 1, upper groove-like recesses 2, 2, . . . extending in the belt width direction at a constant pitch are formed as upper grooves to correspond to the blocks 10. In the lower surface, lower recesses 3, 3, . . . extending in the belt width direction at a constant pitch are formed as lower grooves to correspond to the upper recesses 2, 2, . . . . In the upper surface of each tension band 1, an upper cog 4 is formed between each pair of the upper recesses 2, 2, . . . . In the lower surface of each tension band 1, a lower cog 5 is formed between each pair of the lower recesses 3, 3, . . . .

The hard rubber of the shape-retaining rubber layer 1a is formed by reinforcing H-NBR rubber reinforced by, for example, zinc methacrylate, using short fibers such as aramid fibers and nylon fibers. Thus, the hard rubber highly heat resistive and less subject to permanent deformation is used. The hard rubber needs to have a hardness of 75° or higher when measured with a JIS-C hardness meter.

Upper and lower canvas layers 6 and 7 are formed on the upper and lower surfaces of each tension band 1 by integrally adhering canvases, which have been subjected to glue rubber processing.

On the other hand, as shown in FIGS. 1, 3, and 5, the blocks 10 have cutout slit-like fit portions 11 and 11, in which each tension band 1 is detachably fitted from the width direction, on the right and left sides in the belt width direction. The right and left side surfaces except for the fit portions 11 are contact sections 12 and 12 abutting on the groove surface of a pulley (not shown) such as a variable speed pulley. The belt angle α between the right and left contact sections 12 and 12 of the blocks 10 is equal to the angle of the groove surface of the pulley. Each block 10 is in a substantially H-shape including upper and lower beams 10a and 10b extending in the belt width direction (i.e., the right-left direction), and a pillar 10c vertically connecting the centers of the right and left sides of the both beams 10a and 10b. The tension bands 1 and 1 are press-fitted in the fit portions 11 and 11 between the upper and lower beams 10a and 10b of the blocks 10. As a result, the blocks 10, 10, . . . are continuously fixed to the tension bands 1 and 1 in the belt length direction.

Specifically, as shown in FIG. 5, an upper projection 15 is formed, in the upper wall of the fit portion 11 of each block 10, as an upper tooth meshing with the corresponding upper recess 2 in the upper surface of the tension band 1. A lower projection 16 is formed, in the lower wall of the fit portion 11, as a lower tooth meshing with the corresponding lower recess 3 in the lower surface of the tension band 1. The upper projections 15 are arranged in parallel to the lower projections 16. The upper and lower projections 15 and 16 of the blocks 10 mesh with the upper and lower recesses 2 and 3 of the tension bands 1, thereby engaging and fixing the blocks 10, 10, . . . to the tension bands 1 and 1 in the belt length direction by press-fitting. In this engaged and fixed state, the contact sections 12 being the side surfaces of the blocks 10 abut on the groove surface of the pulley (the outer side surfaces of each tension bands 1 may also abut thereon). The upper and lower projections 15 and 16 (i.e., teeth) of the blocks 10 mesh with the upper and lower recesses 2 and 3 (i.e., grooves) of the tension bands 1, thereby transmitting power with the pulley.

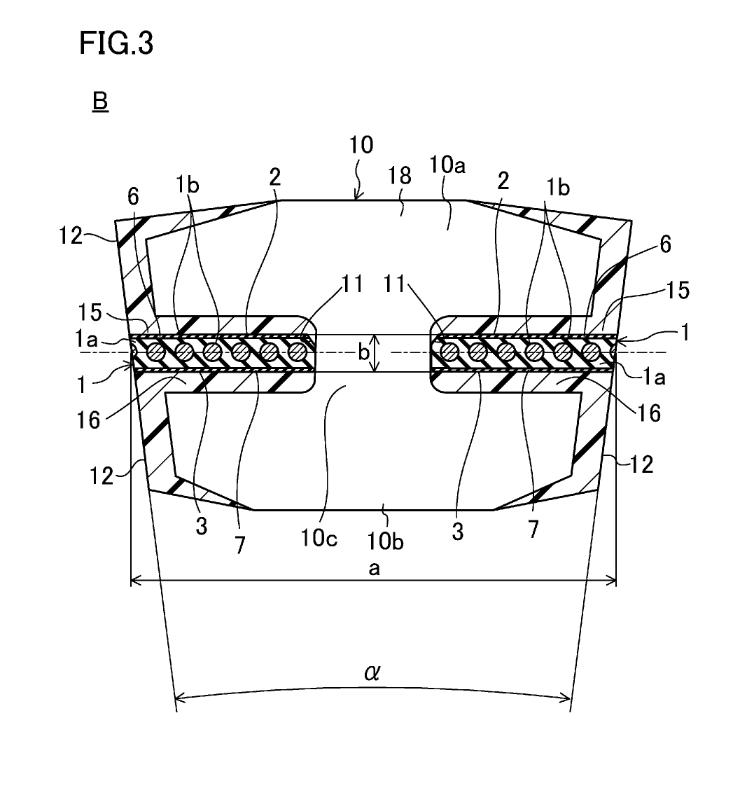

As shown in FIG. 3, each block 10 is formed by burying a reinforcing member 18 in hard resin such as phenolic resin, which is reinforced by, for example, short carbon fibers, to be located in a substantially middle of the block 10. The reinforcing member 18 is, for example, a light aluminum alloy which is a material having higher elastic modulus than the hard resin. As such, each block 10 includes the hard resin portion forming the periphery of the fit portions 11 and the contact sections 12 and 12, and the reinforcing member 18 forming the other portions. The reinforcing member 18 should not appear on the surfaces of the blocks 10 at the periphery of the fit portions 11 and the contact sections 12 and 12 of the right and left side surfaces (i.e., sliding contact sections with the groove surface of the pulley). In other portions, the reinforcing member 18 may be exposed to the surfaces of the blocks 10.

A meshing thickness b of each tension band is slightly greater than a meshing thickness d of each block (b>d). The meshing thickness b is the thickness of each tension band 1 made of the hard rubber between the upper and lower recesses 2 and 3, that is, as shown in FIG. 4, the distance between the bottoms of the upper recesses 2 (specifically, the upper surface of the upper canvas layer 6) and the bottoms of the lower recesses 3 (specifically, the lower surface of the lower canvas layer 7) corresponding to the upper recesses 2. The meshing thickness d of is the thickness of the meshing gap of each block 10, that is, as shown in FIG. 5, the distance between the lower end of the upper projection 15 and the upper end of the lower projection 16 of the block 10. As a result, when the blocks 10 are attached to the tension bands 1, the tension bands 1 are compressed by the blocks 10 in the thickness direction, thereby providing a fastening margin b−d (>0).

As a further feature of the present disclosure follows. As shown in FIG. 3, assume that the belt pitch width a is the belt width of each tension band 1 at the position of the cord 1b in each block 10. In this embodiment, the belt pitch width a and the meshing thickness b of each tension band (i.e., the thickness between the bottoms of the upper recesses 2 and the bottoms of the lower recesses 3, see FIG. 4) satisfy the following relationship.

b/a≦0.08 (1)

That is, the meshing thickness b of each tension band is 8% or smaller of the belt pitch width a. Specifically, b/a preferably ranges from 0.04 to 0.08. For example, where the belt pitch width a is 25 mm, the meshing thickness b of each tension band preferably ranges from 1.0 to 2.0 mm. A more preferable relationship is as follows.

b/a≦0.05 (2)

That is, the meshing thickness b of each tension band is preferably 5% or smaller of the belt pitch width a.

At the same time, as shown in FIG. 4, assume that a total thickness c of each tension band is the thickness of each tension band 1 between the cogs 4 and 5 at the upper and lower sides in the portions other than the upper recesses 2 and the lower recesses 3 (i.e., the upper and lower grooves). The total thickness c of each tension band and the meshing thickness b of each tension band satisfy the following relationship.

c/b≧2.0 (3)

That is, the total thickness c of each tension band is two or more times as great as the meshing thickness b of each tension band. Specifically, c/b preferably ranges from 2.0 to 4.6. For example, where the meshing thickness b of each tension band ranges from 1.0 to 2.0 mm, the total thickness c of each tension band preferably ranges from 2.2 to 5.5 mm.

The belt pitch width a is related to the holding area of the tension band 1 holding the blocks 10. In addition to simply reducing the meshing thickness b of each tension band, the meshing thickness b of each tension band and the belt pitch width a need to satisfy the above expression (1) or (2).

FIGS. 1-5 do not precisely show the relationship among the belt pitch width a, the meshing thickness b of each tension band, the total thickness c of each tension band, and the meshing thickness d of each block.

In this embodiment, the belt pitch width a and the meshing thickness b of each tension band of the v-belt B for high load transmission satisfy the following relationship.

b/a≦0.08

That is, the meshing thickness b of each tension band is 8% or smaller of the belt pitch width a. The meshing thickness b of each tension band is sufficiently small relative to the belt pitch width a, thereby reducing the thickness of the tension band 1. This reduces the push-up of the upper beams 10a of the blocks 10 by the thermal expansion, and the increase in the distance between the upper and lower beams 10a and 10b, when the belt B is wound around the variable speed pulley of the continuously variable transmission to run. Thus, the change in the thrust-tension conversion ratio, and the change in the belt tension according thereto are reduced, even after the running time of the belt B has passed. This reduces the thrust (i.e., the thrust pushing a movable sheave of the variable speed pulley in the axis direction) of a drive unit, which opens and closes the variable speed pulley of the transmission to change the gear ratio. As a result, the initial heat built-up of the belt B decreases, and the efficiency and the durability of the belt B improve.

Where the belt pitch width a and the meshing thickness b of each tension band satisfy the relationship of b/a≦0.05 (i.e., where the meshing thickness b of each tension band is 5% or smaller of the belt pitch width a), the change in the thrust-tension conversion ratio with the running time of the belt B decreases more effectively.

In this case, the belt pitch width a and the meshing thickness b of each tension band satisfy the relationship of b/a≦0.08, thereby reducing the thickness of the tension band 1. This reduces the force holding the blocks 10 by the meshing of the upper projections 15 with the upper recesses 2 and of the blocks 10, and the meshing of the lower projections 16 of the blocks 10 with the lower recesses 3. However, assume that the relationship between the meshing thickness b and the total thickness c of each tension band 1 between the cogs 4 and 5 of the upper and lower surfaces is expressed by c/b≧2.0. Since the total thickness c of each tension band between the cogs 4 and 5 is great, the blocks 10 are held by the cogs 4 and 5, which have a great thickness relative to the tension band 1. As a result, the holding force of the blocks 10 holding the tension band 1 does not decrease, thereby reliably reducing the vibrations of the tension bands 1.

### Other Embodiments

In this embodiment, the reinforcing member 18 is inserted into each block. In the present disclosure, however, the entire blocks may be made of resin without using the reinforcing member 18. This structure provides similar effects and advantages. The V-belt B for high load transmission according to this embodiment is not only wound around the variable speed pulley of the belt-type continuously variable transmission, but may be used for belt-type transmissions including a constant speed pulley (i.e., a V pulley).

### EXAMPLES

Next, specifically conducted examples will be described. V-belts for high load transmission having the structure of the above-described embodiment are fabricated as first to sixth examples and first to third comparative examples. The belt angle α of each belt (i.e., the angle between the sliding surfaces being the side surfaces of each block) is 26°. The belt pitch width a is 25 mm. The pitch of the blocks in the belt length direction is 3 mm. The thickness of each block (i.e., the thickness in the belt length direction) is 2.95 mm. The belt length is 612 mm.

Each used block is formed by inserting and molding a reinforcing member made of a high-strength light aluminum alloy with a thickness 2 mm into phenolic resin. Blocks, which are entirely made of resin without using the reinforcing member made of the aluminum alloy, provide similar advantages.

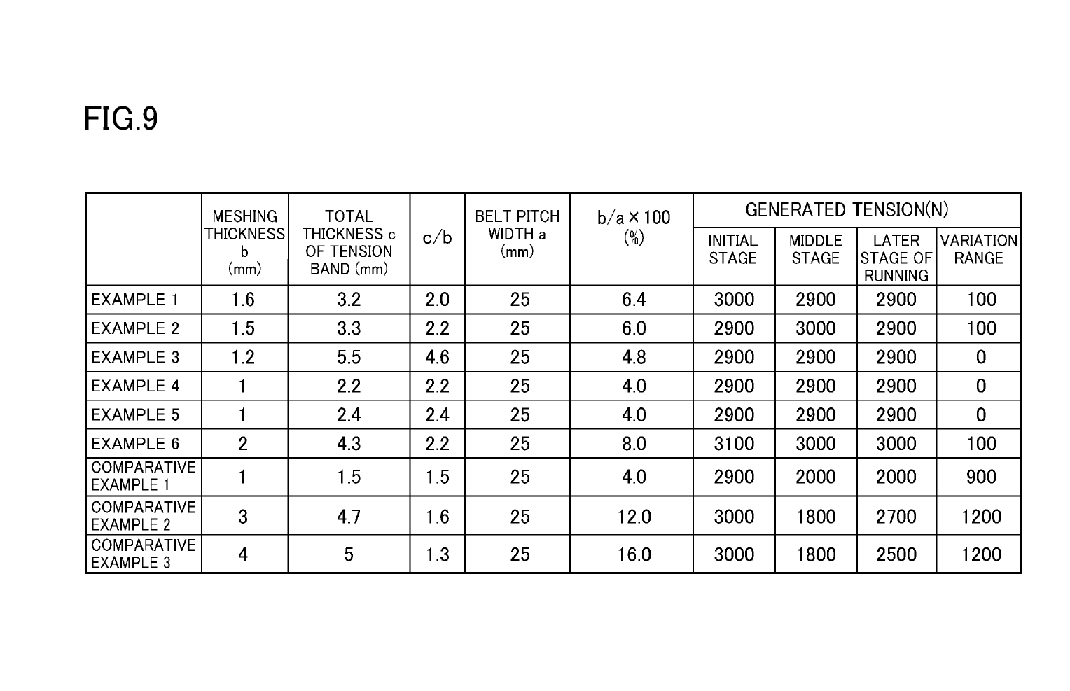

The belts according to the first to sixth examples and the first to third comparative examples have different meshing thicknesses b of the tension bands and different total thicknesses c (see FIG. 9).

### First Example

The meshing thickness b of each tension band is 1.6 mm and the total thickness c of each tension band is 3.2 mm. Therefore, c/b is 2.0, and b/a is 0.064 (i.e., 6.4%).

### Second Example

The meshing thickness b of each tension band is 1.5 mm and the total thickness c of each tension band is 3.3 mm. Therefore, c/b is 2.2, and b/a is 0.060 (i.e., 6.0%).

### Third Example

The meshing thickness b of each tension band is 1.2 mm and the total thickness c of each tension band is 5.5 mm. Therefore, c/b is 4.6, and b/a is 0.048 (i.e., 4.8%).

### Fourth Example

The meshing thickness b of each tension band is 1.0 mm and the total thickness c of each tension band is 2.2 mm. Therefore, c/b is 2.2, and b/a is 0.04 (i.e., 4.0%).

### Fifth Example

The meshing thickness b of each tension band is 1.0 mm and the total thickness c of each tension band is 2.4 mm. Therefore, c/b is 2.4 and b/a is 0.04 (i.e., 4.0%).

### Sixth Example

The meshing thickness b of each tension band is 2.0 mm and the total thickness c of each tension band is 4.3 mm. Therefore, c/b is 2.2, and b/a is 0.08 (i.e., 8.0%).

### First Comparative Example

The meshing thickness b of each tension band is 1.0 mm and the total thickness c of each tension band is 1.5 mm. Therefore, c/b is 1.5, and b/a is 0.04 (i.e., 4.0%).

### Second Comparative Example

The meshing thickness b of each tension band is 3.0 mm and the total thickness c of each tension band is 4.7 mm. Therefore, c/b is 1.6, and b/a is 0.12 (i.e., 12.0%).

### Third Comparative Example

The meshing thickness b of each tension band is 4.0 mm and the total thickness c of each tension band is 5.0 mm. Therefore, c/b is 1.3, and b/a is 0.16 (i.e., 16.0%).

### Evaluation of Belt

The temporal change in the belt tension, the high-speed durability, the initial heat built-up, the change in the fastening margin, the belt transmission capability, and belt efficiency are evaluated in each of the above-described examples and comparative examples.

### (1) Temporal Change in Belt Tension

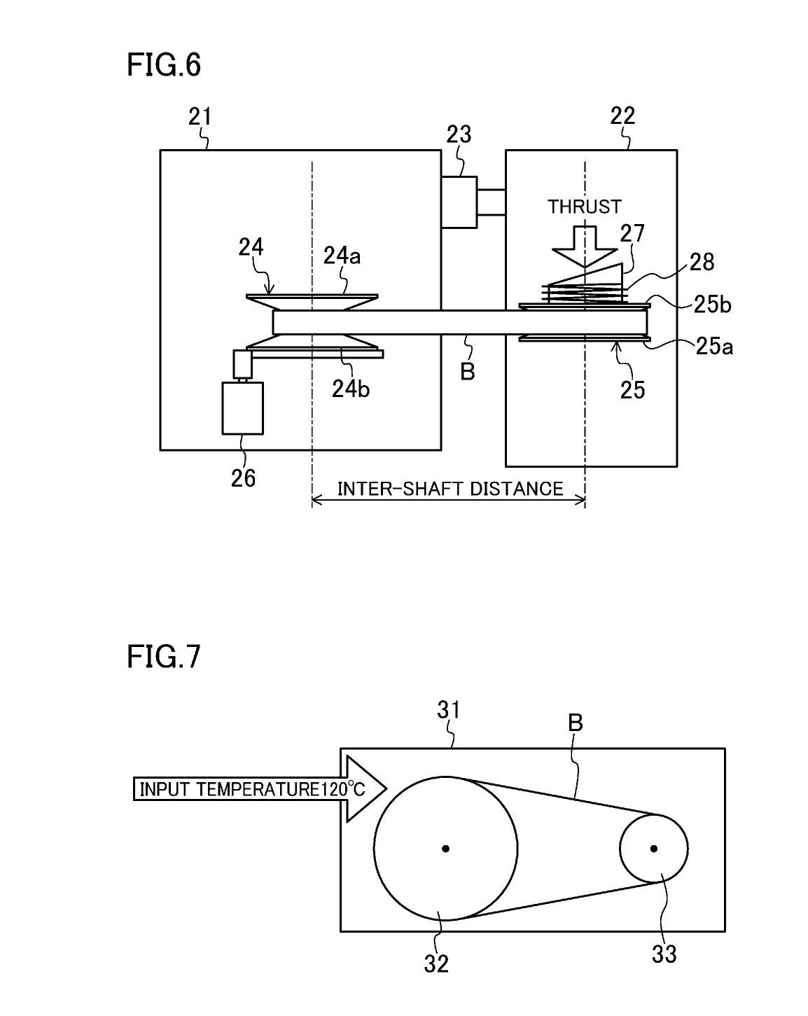

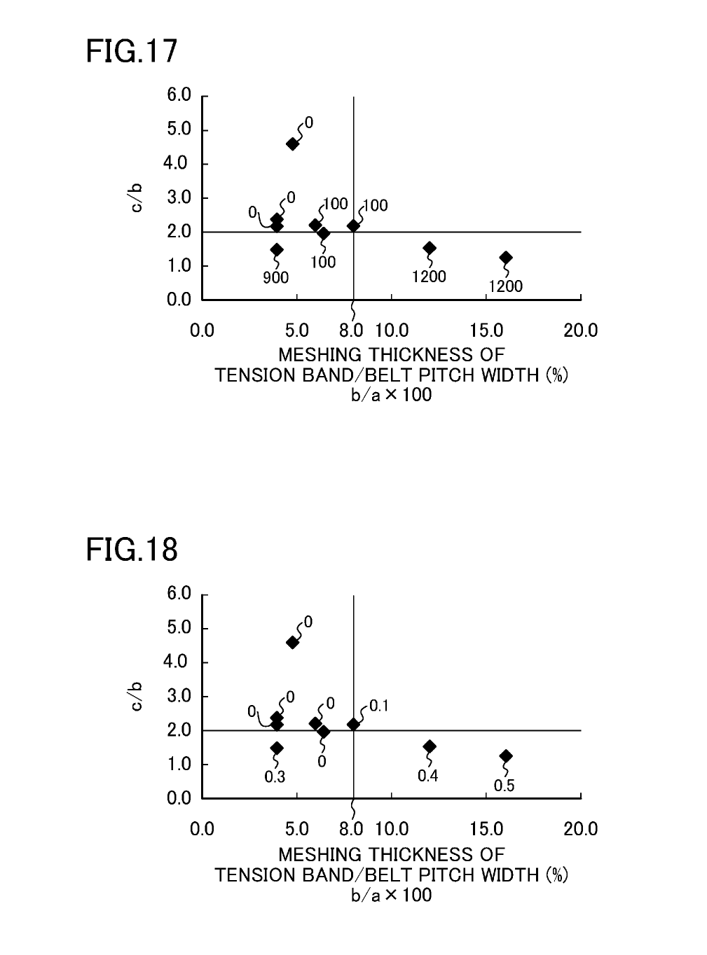

The temporal change in the belt tension was measured in each of the examples and the comparative examples using equipment for measuring and testing the belt tension (i.e., the inter-shaft power) shown in FIG. 6. Specifically, a drive base 21 and a driven base 22, which move close to and away from each other, pivotally support drive and driven pulleys 24 and 25, which are variable speed pulleys including fixed and movable sheaves 24a, 24b, 25a, and 25b, respectively. The drive base 21 and the driven base 22 were connected via a load cell 23, thereby fixing the inter-shaft distance between the drive and driven pulleys 24 and 25 to 148.5 mm. The drive pulley 24 was drivingly connected to a drive motor 26. The driven pulley 25 was drivingly connected to a load DC motor (not shown) and applied with a constant load torque of 60 N·m. The V-belt B for high load transmission of each of the examples and the comparative examples was wound around the drive and driven pulleys 24 and 25. The speed ratio was fixed to 1.8. A torque cam 27 and a spring 28 applied thrust to the movable sheave 25b of the driven pulley 25 in the axis direction toward the fixed sheave 25a. In this state, the drive motor 26 rotated the drive pulley 24 at a constant speed of 3000 rpm to run the belt B. The inter-shaft power detected by the load cell 23 during the run was measured as the belt tension. The temporal change in the belt tension was obtained from the measurement values at an initial running stage (i.e., 0-24 hours after the start of running) of the belt B, at a middle stage (i.e., 24-48 hours after the start of running), and in a later stage (i.e., 48 or more hours after the start of running), which is represented by a stable measurement value. The temperature of each belt B was 120° C. FIGS. 9-11, and 17 show the results.

### (2) High-Speed Durability

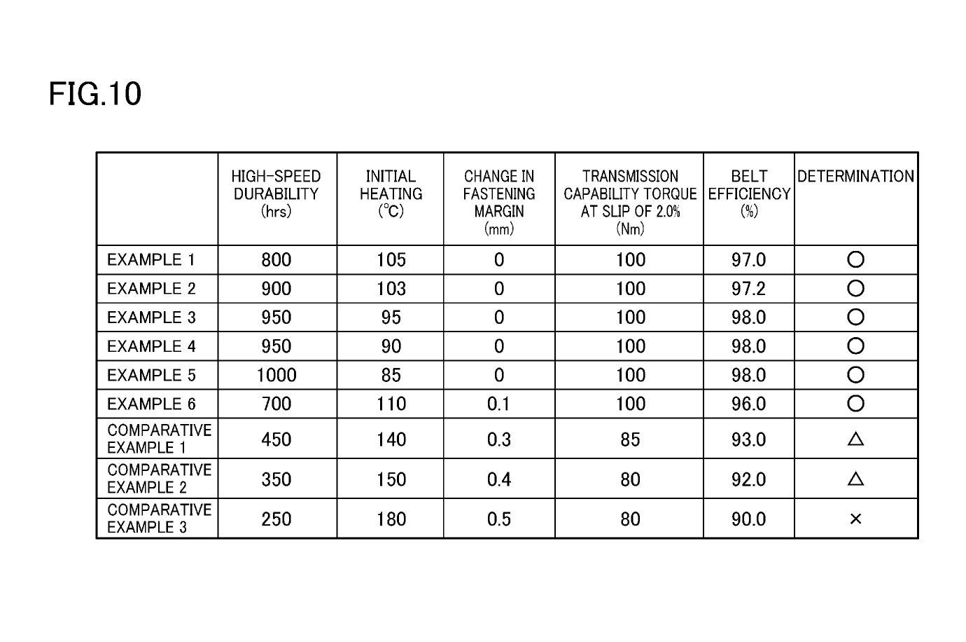

The high-speed, high-load durability and the heat resistance were measured in each of the examples and the comparative examples using equipment for testing high-speed durability shown in FIG. 7. Specifically, a drive pulley 32, which is a constant speed pulley with a pitch size of 133.6 mm and a driven pulley 33, which is a constant speed pulley with a pitch size of 61.4 mm, were provided in a test box 31, to which an atmosphere at 120° C. was input as heat capacity. The belt B of each of the examples and the comparative examples was wound around the both pulleys 32 and 33. The drive pulley 32, which rotated with a shaft torque of 63.7 N·m at a high speed of 5016±60 rpm, was measured for 300 hours. FIGS. 10 and 12 show the results.

### (3) Initial Heat Built-Up

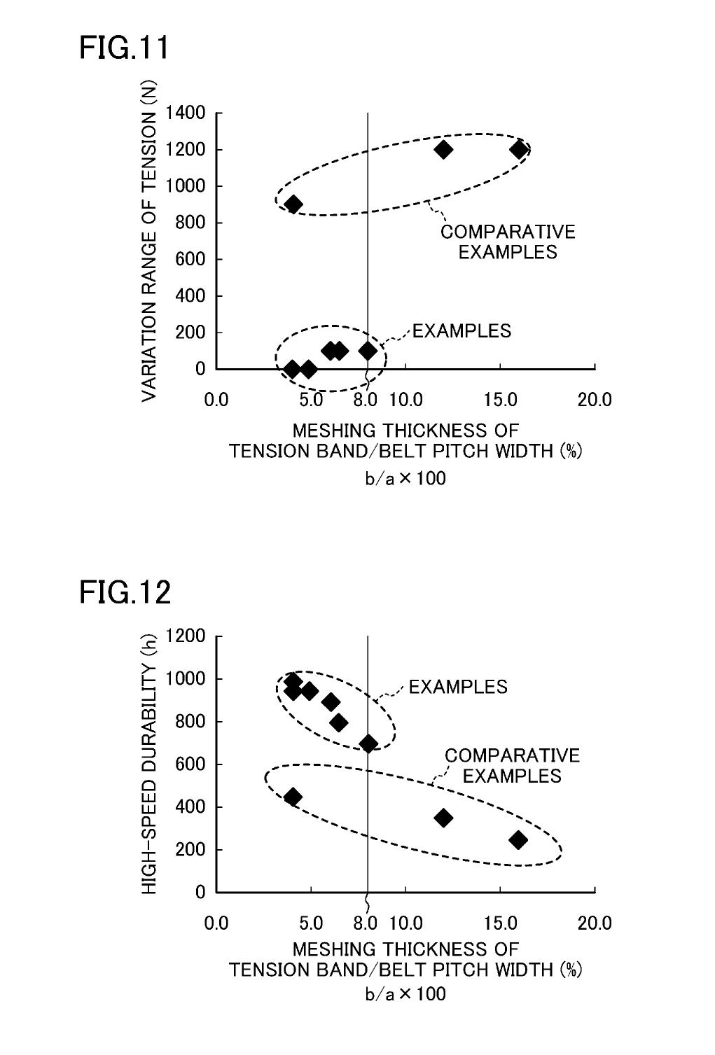

At the test of the high-speed, high-load durability and the heat resistance, the heating temperature of each belt B at the initial running stage (2 hours after the start of running) was measured. FIGS. 10 and 13 show the results.

### (4) Change in Fastening Margin

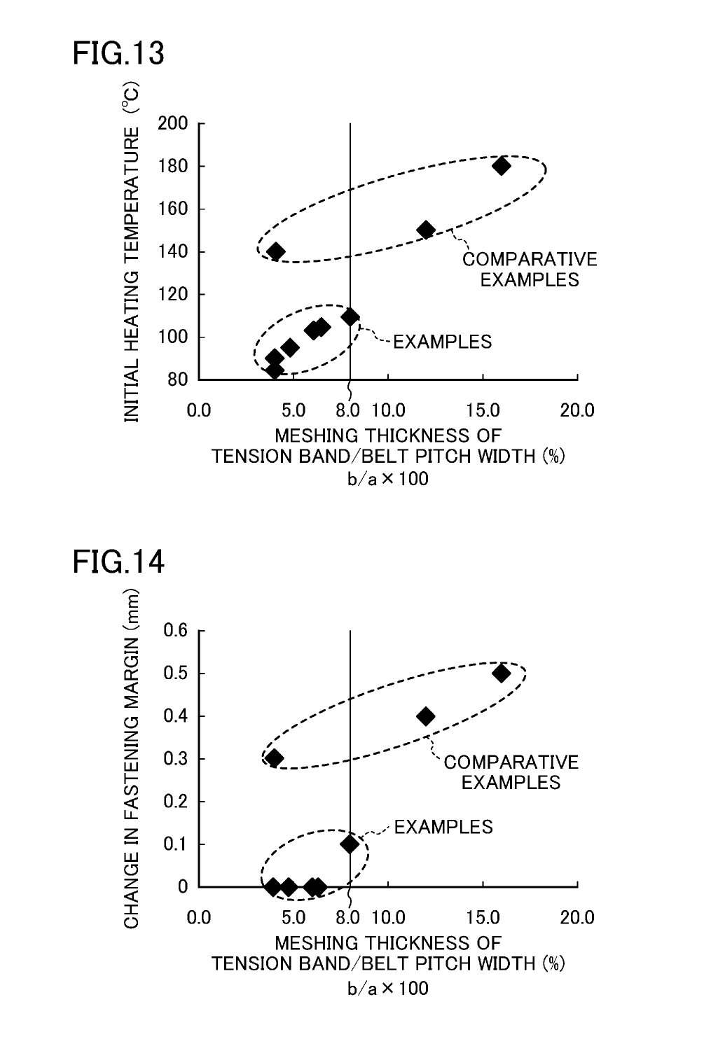

At the test of the high-speed, high-load durability and the heat resistance, the change in the fastening margin after 300 hours has passed after the start of running was measured. The fastening margin was obtained by subtracting the meshing thickness d of each block from the thickness b of each tension band. FIGS. 10, 14, and 18 show the results.

### (5) Belt Transmission Capability

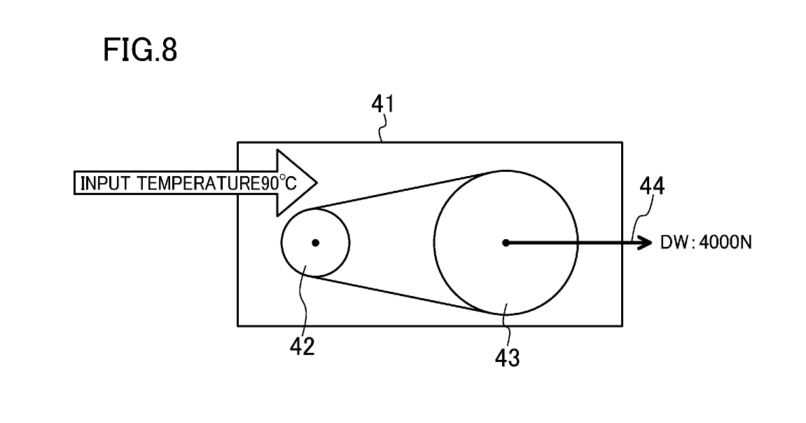

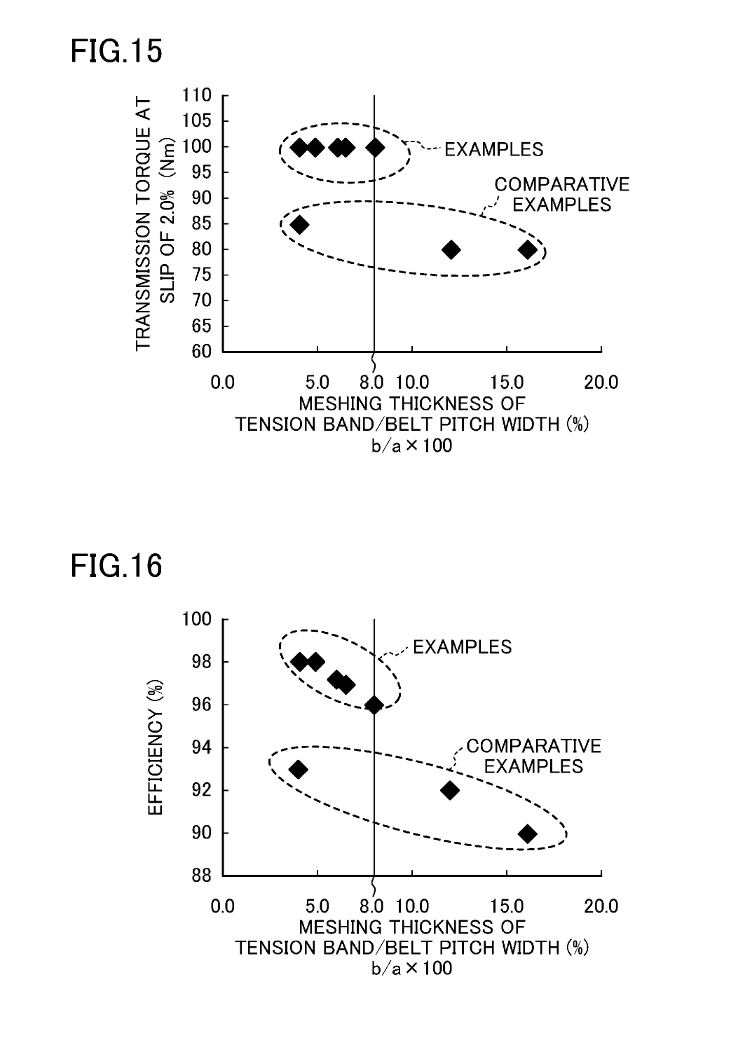

The belt transmission capability was measured in the examples and the comparative examples using equipment for testing transmission capability shown in FIG. 8. Specifically, a drive pulley 42, which is a constant speed pulley with a pitch size of 65.0 mm, and a driven pulley 43, which is a constant speed pulley with a pitch size of 130.0 mm, were provided to move close to and away from each other in a test box 41, to which an atmosphere at 90° C. was input as heat capacity. The belt B of each of the examples and the comparative examples was wound around the both pulleys 42 and 43. The driven pulley 43 bore a deadweight 44 of 4000 N in the direction away from the drive pulley 42. In this state, the drive pulley 42 rotated at a speed of 2600±60 rpm. The shaft torque of the drive pulley 42 was slowly increased and the shaft torque was measured when the slip ratio of the belt B was 2%. FIGS. 10 and 15 show the results.

### (6) Belt Efficiency

The belt efficiency was measured using equipment for testing belt transmission capability shown in FIG. 8. The belt efficiency was measured in the same layout and conditions as the measurement of the belt transmission capability. At this time, the speed of the drive pulley 42, the speed of the driven pulley 43, the torque of the drive pulley 42, and the torque of the driven pulley 43 were measured to obtain the belt efficiency based on the following equation. Where the belt efficiency is η,

efficiency η(%)={(speed of driven pulley×torque of driven pulley)/(speed of drive pulley×torque of drive pulley)}×100

FIGS. 10 and 16 show the results.

In FIG. 10, circles represent good, and triangles and crosses represent bad in the columns of determination.

The above-described results show that, in the first to sixth examples, in which the meshing thickness b of each tension band is 8% or smaller of the belt pitch width a, the variation range of the belt tension is 100 N or narrower. That is, the temporal change is small. In particular, in the third to fifth examples, in which the meshing thickness b of each tension band is 5% or smaller of the belt pitch width a, the variation range of the belt tension is 0 N. That is, there is no temporal change. On the other hand, in the second comparative example and the third comparative example, the meshing thickness b of each tension band is greater than 8% of the belt pitch width a, and the variation range is wide. In the first comparative example, the meshing thickness b of each tension band is 4% (lower than 8%) of the belt pitch width a, but the variation range is as wide as 900 N. This is because the ratio c/b is small, that is, the heights of the cogs (i.e., the total thickness of the tension band) are insufficient, and the vibrations of the blocks increase so that the blocks are inclined in the front-back direction to enter the pulley. This applies thrust to deteriorate the transmission efficiency to the tension band.

In the first to sixth examples, the meshing thickness b of each tension band is 8% or smaller of the belt pitch width a, and the total thickness c of each tension band is two or more times as great as the meshing thickness b of each tension band. These examples clearly show that the high-speed durability, the initial heat built-up, the change in the fastening margin, the transmission capability, and the belt efficiency dramatically improve. These examples are significantly distinguishable from the first to third comparative examples.

The present disclosure provides a V-belt for high load transmission in which resin blocks are engaged with and fixed to tension bands containing rubber. The temporal change in the tension is small during the running of the belts. As compared to conventional art, the present invention provides dramatically high performance such as heat built-up, running durability, and belt efficiency. Therefore, the present disclosure is significantly useful and is highly industrially applicable.

What is claimed is:

1. A V-belt for high load transmission comprising:
tension bands, each including
a cord buried inside a shape-retaining rubber layer, and
numbers of upper and lower grooves arranged in a belt length direction to vertically correspond to each other, the upper grooves being formed in an upper surface facing a back of the belt, and the lower grooves being formed in a lower surface facing a bottom of the belt; and
numbers of blocks, each including
fit portions in which the tension bands are press-fitted,
an upper tooth formed in upper surfaces of the fit portions and meshing with the upper grooves of the tension bands, and
a lower tooth formed in lower surfaces of the fit portions and meshing with the lower grooves of the tension bands, wherein
the tension bands are fitted in the fit portions of the blocks, thereby engaging and fixing the blocks with and to the tension bands,
meshing of the teeth of the blocks with the grooves of the tension bands transmits power,
a belt pitch width a being a belt width at a position of the cord of each tension band, and a meshing thickness b of the tension band between lower ends of the upper grooves and upper ends of the lower grooves satisfy a relationship of b/a≦0.08, and
the meshing thickness b of the tension band and a total thickness c of the tension band being a thickness of each of cogs, which are portions of the tension band other than the upper and lower grooves, satisfy a relationship of c/b≧2.0.

2. The V-belt for high load transmission of claim 1, wherein
a ratio b/a of the meshing thickness b of the tension band to the belt pitch width a ranges from 0.04 to 0.08.

3. The V-belt for high load transmission of claim 1, wherein
the belt pitch width a and the meshing thickness b of the tension band satisfy a relationship of b/a≦0.05.

4. The V-belt for high load transmission of claim 2, wherein
the belt pitch width a and the meshing thickness b of the tension band satisfy a relationship of b/a≦0.05.

5. The V-belt for high load transmission of claim 1, wherein
a ratio c/b of the total thickness c of the tension band to the meshing thickness b of the tension band ranges from 2.0 to 4.6.

6. The V-belt for high load transmission of claim 2, wherein
a ratio c/b of the total thickness c of the tension band to the meshing thickness b of the tension band ranges from 2.0 to 4.6.

7. The V-belt for high load transmission of claim 3, wherein
a ratio c/b of the total thickness c of the tension band to the meshing thickness b of the tension band ranges from 2.0 to 4.6.

8. The V-belt for high load transmission of claim 1, wherein
the meshing thickness b of the tension band ranges from 1.0 to 2.0 mm.

9. The V-belt for high load transmission of claim 1, wherein
the total thickness c of the tension band ranges from 2.2 to 5.5 mm.

10. The V-belt for high load transmission of claim 1 is wound around a variable speed pulley of a belt-type continuously variable transmission.
